(19) United States
(12) Patent Application Publication
(10) Pub. No.: US 2018/0155894 A1
(43) Pub. Date: Jun. 7, 2018

(54) Pile Cutting Device

(71) Applicant: Westcap Group Inc., Hythe (CA)

(72) Inventor: Lonny James Thiessen, Hythe (CA)

(21) Appl. No.: 15/829,095

(22) Filed: Dec. 1, 2017

Related U.S. Application Data
(60) Provisional application No. 62/428,836, filed on Dec. 1, 2016.

(51) Int. Cl. E02D 9/00; E02F 3/96; B23D 47/04; B23D 45/00; B23D 47/02

(52) U.S. Cl. CPC E02D 9/00; E02F 3/96; B23D 47/02; B23D 45/003; B23D 47/04

(57) ABSTRACT

A pile cutting device is used with a work vehicle including a tool supporting arm assembly for cutting a pile. The device has a main frame carried on the arm assembly of the work vehicle. A first clamp on the frame is clamped about the pile for fixing the frame relative to the pile. A cutting assembly on the main frame includes a saw blade supported on a cutter linkage to move the blade about the pile and cut a pile section from the pile when the remaining lower portion of the pile remains secured within the lower clamp. A second clamp on the frame is clamped about the cut pile section of the pile before cutting. The first clamp is released after cutting so that the cut pile section within the second clamp can be moved away from the remaining lower portion of the pile together with work vehicle subsequent to cutting.

This application claims the benefit under 35 U.S.C. 119(e) of U.S. provisional application Ser. No. 62/428,836, filed Dec. 1, 2016.

### FIELD OF THE INVENTION

The present invention relates to a pile cutting device for cutting a pile when attached to a tool supporting arm assembly of a work vehicle, for example the lifting arms of a skid steer loader. More particularly, the present invention relates to a pile cutting device including (I) a cutting linkage which supports a circular saw blade for movement in a circumferential direction about a full circumference of the pile to be cut, (ii) a lower clamp below the saw blade for locating the saw blade relative to the pile, and (iii) an upper clamp above the saw blade for retaining a pile section which has been cut from the pile.

### BACKGROUND

The use of piles is common in the construction industry for providing a stable foundation to many different types of structures. In many instances, the installation of a pile involves penetrating a pre-formed pile member into the ground using suitable pile driving equipment. Once a desired penetration depth has been achieved, the pile is typically cut-off at a prescribed height. When using tubular metal piles, the cutting of the pile is commonly achieved by securing an upper section of the pile to a work vehicle, for example the lift arms of a loader, followed by manually displacing a hand-held circular saw about the pile to cut the upper section of the pile from the remainder of the pile. Manually supporting the saw is labour intensive. Furthermore, it is difficult to cut the pile at a prescribed height.

Various attempts have been made to support a circular saw on the lift arms or boom of a work vehicle as described in the following documents: International publication no. WO2004/070120 by Rajala et al, US patent application publication nos. US 2010/0018514 by Wills and 2011/016795 by Boudreault et al, and U.S. Pat. No. 9,109,339 by Morimoto, U.S. Pat. No. 4,987,935 by Corcoran et al, and U.S. Pat. No. 4,318,391 by Wachs et al. In each instance in the prior art, the saw blade is supported on a frame which is difficult to accurately align with the pile to be cut. Furthermore, even when some alignment of the frame relative to the pile is provided, the saw blade cannot be adjusted to a prescribed height relative to the pile subsequent to alignment of the frame relative to the pile, which considerably limits the accuracy of the cutting height.

### SUMMARY OF THE INVENTION

According to one aspect of the invention there is provided a pile cutting device for use with a work vehicle including a tool supporting arm assembly for cutting a pile, the device comprising:

a main frame arranged to be supported on the arm assembly of the work vehicle;

a first clamp supported on the main frame and arranged to be clamped about the pile for fixing the main frame relative to the pile;

a cutting assembly including (i) a cutter linkage which is supported on the main frame above the first clamp, and (ii) a saw blade rotatably supported on the cutter linkage so as to be movable with the cutter linkage relative to the main frame so as to be arranged to cut a cut pile section from the pile while the pile remains secured within the lower clamp; and a second clamp supported on the main frame so as to be arranged to be clamped about the cut pile section of the pile.

The use of a first clamp for fixing the main frame relative to the pile together with a cutting assembly which is above the clamp allows the cutting assembly to be accurately located relative to the pile to be cut for accurately cutting off the pile at a prescribed height.

Preferably the cutting assembly is supported on the main frame so as to be adjustable in height relative to the first clamp and the second clamp in a direction of the pile axis.

Preferably the cutter linkage is arranged to support the saw blade for movement in a circumferential direction relative to the pile axis about a full circumference of the pile received in the first and second clamps.

The cutter linkage may further comprise (i) a support member mounted on the main frame which is arranged to extend circumferentially partway about the pile axis, and (ii) a linkage member supported on the support member to extend circumferentially partway about the pile axis, in which the linkage member supports the saw blade rotatably thereon so as to be movable in the circumferential direction relative to the support member.

In the illustrated embodiment, each of the support member and the linkage member is generally C-shaped so as to define a circumferential gap between opposing ends of the respective member. In this instance, the linkage member is preferably movable in two opposing directions from a neutral position in which the circumferential gaps are aligned with one another for receiving the pile therethrough towards two deflected positions respectively in which the deflected positions are 360 degrees apart from one another in the circumferential direction. The cutter linkage may further include a pair of driving gears rotatably supported on the support member for rotation about respective gear axes oriented parallel to the pile axis and a rack of gear teeth on the linkage member along an circumferential path about the pile axis, in which the driving gears are spaced apart in the circumferential direction by a distance which is greater than the circumferential gap on the linkage member such that at least one driving gear is arranged for meshing engaging with the rack of gear teeth throughout displacement of the linkage member relative to the support member.

The support member of the cutter linkage may be supported on the main frame so as to be adjustable in orientation relative to the pile axis of the main frame.

Preferably the saw blade is supported on the cutter linkage so as to be also adjustable in a radial direction relative to the pile axis of the main frame.

Typically, when cutting hollow tubular piles, the saw blade has a radius which is less than a diameter of the pile.

The second clamp is preferably also supported on the main frame so as to be adjustable in height relative to the main frame, the first clamp, and the cutting assembly in a direction of the pile axis. When the main frame includes at least one support rail extending in a direction of the pile axis, the second clamp and the cutting assembly may be independently supported on said at least one support rail of the main frame so as to be independently adjustable in height relative to the main frame in the direction of the pile axis.

Each of the first and second clamps may include (i) a rear clamping member arranged to be supported in fixed relation to the main frame rearwardly of the pile axis and (ii) a pair of clamping arms pivotally supported at laterally opposing sides of the rear clamping member to protrude from the main frame forwardly of the pile axis, in which the clamping arms are pivotal about a pivot axis oriented in the direction of the pile axis between a released position arranged to receive the pile inserted therebetween into the second clamp and a clamped position arranged to clamp the pile between the rear clamping member and the pair of clamping arms. The rear clamping member of each clamp is preferably adjustable relative to the main frame in a radial between a plurality of different mounted positions. The rear clamping member of the second clamp may comprise a channel member comprising two leading edges extending in a direction of the pile axis which are arranged to engage the pile and a connection portion joined between the two leading edges.

In the illustrated embodiment, the work vehicle comprises a skid steer loader and the tool supporting arm assembly comprises lift arms of the skid steer loader. In further embodiments, however, the work vehicle may comprise a tractor or loader of various types in which the tool supporting arm assembly comprises an articulated boom or a pair of lifting arms.

According to another aspect of the present invention there is provided a pile cutting device for use with a work vehicle including a tool supporting arm assembly for cutting a pile, the device comprising:

a main frame arranged to be supported on the arm assembly of the work vehicle for receiving the pile therein along a pile axis of the pile cutting device;

an upper clamp supported on the main frame so as to be arranged to be clamped about a pile section to be cut from the pile.

a cutting assembly including (i) a cutter linkage which is supported on the main frame below the upper clamp, and (ii) a saw blade rotatably supported on the cutter linkage so as to be movable with the cutter linkage relative to the main frame so as to be arranged to cut said pile section from the pile;

the upper clamp being supported on the main frame so as to be adjustable in height relative to the main frame, and the cutting assembly in a direction of the pile axis.

According to a further aspect of the present invention there is provided a pile cutting device for use with a work vehicle including a tool supporting arm assembly for cutting a pile, the device comprising:

a main frame arranged to be supported on the arm assembly of the work vehicle for receiving the pile therein along a pile axis of the pile cutting device; and

a cutting assembly including (i) a cutter linkage which is supported on the main frame, and (ii) a saw blade rotatably supported on the cutter linkage so as to be movable with the cutter linkage relative to the main frame so as to be arranged to cut a cut pile section from the pile when the pile is received along the pile axis of the pile cutting device;

the cutter linkage being arranged to support the saw blade for movement in a circumferential direction relative to the pile axis about a full circumference of the pile received within the pile cutting device.

### BRIEF DESCRIPTION OF THE DRAWINGS

One embodiment of the invention will now be described in conjunction with the accompanying drawings in which:

FIG. 1 is a front perspective view of the pile cutting device;

FIG. 2 is a rear perspective view of the pile cutting device;

FIG. 3 is a front elevational view of the pile cutting device;

FIG. 4 is a side elevational view of the pile cutting device shown supported on the lift arms of a skid steer loading;

FIG. 5 is a top plan view of the pile cutting device;

FIG. 6 is a sectional view of one of the rails of the pile cutting device;

FIG. 7 is a schematic top plan view of the cutter linkage of the pile cutting device; and

FIG. 8 is a schematic rear view of the cutter linkage of the pile cutting device.

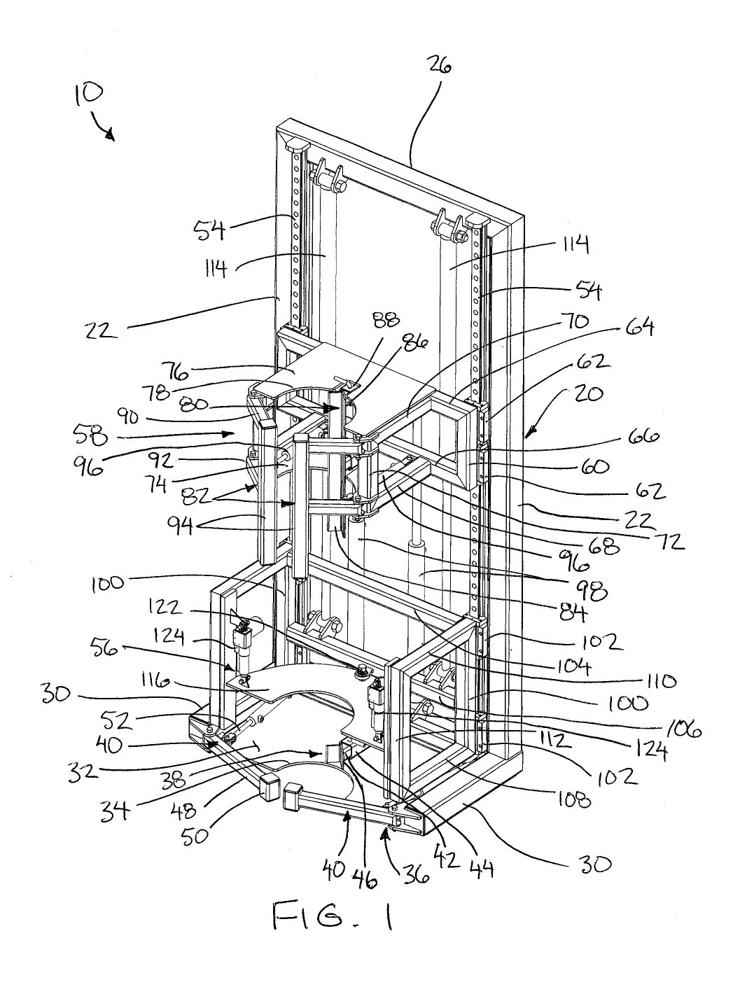

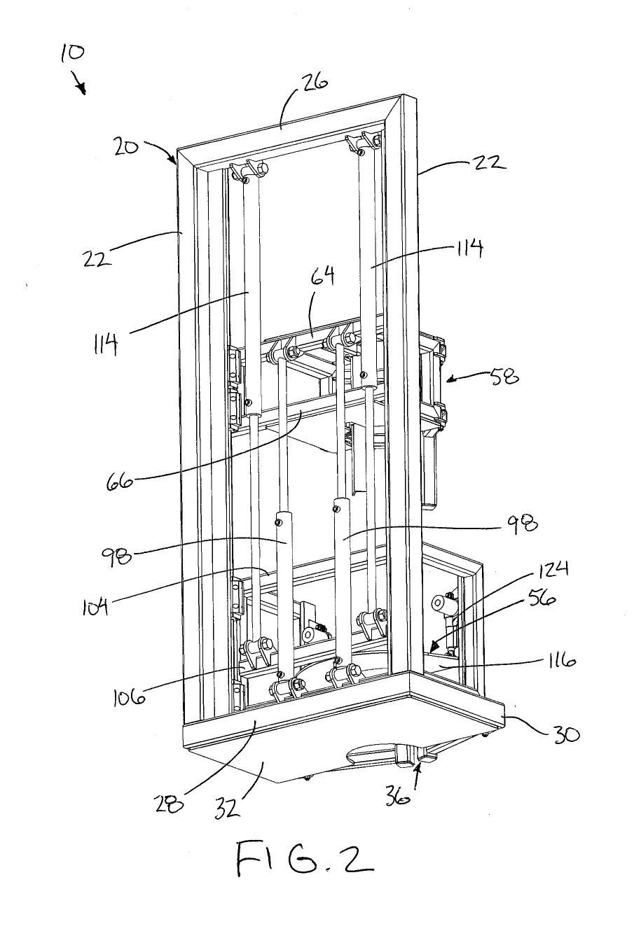

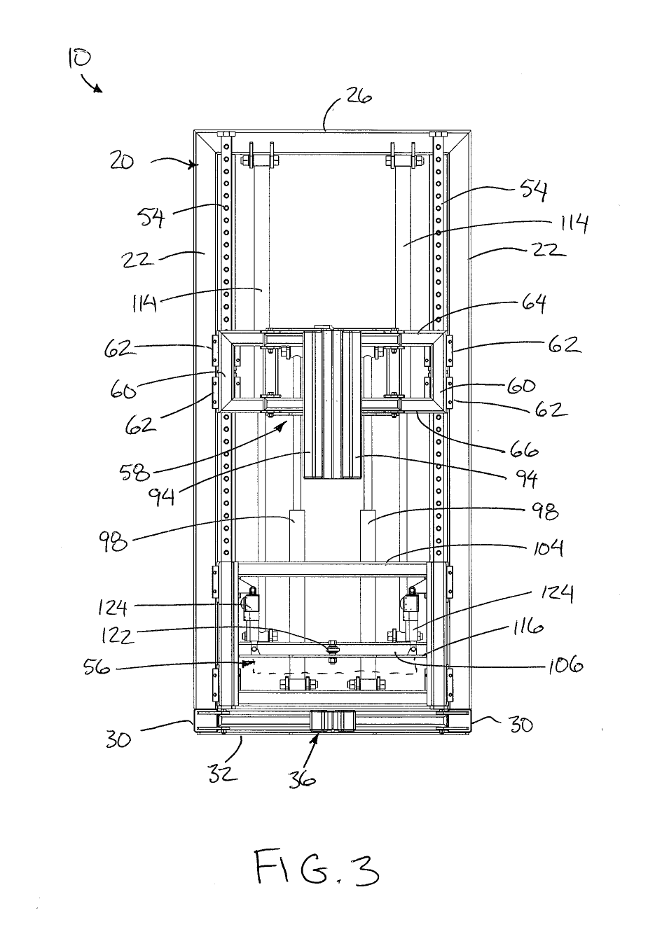

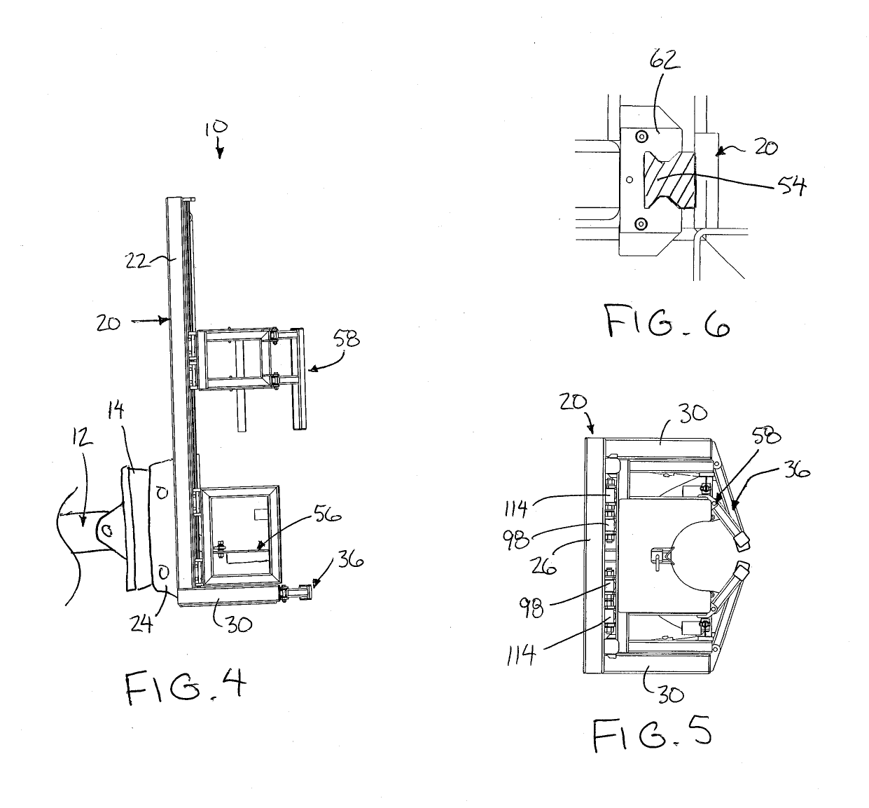

In the drawings like characters of reference indicate corresponding parts in the different figures.

### DETAILED DESCRIPTION

Referring to the accompanying figures, there is illustrated a pile cutting device generally indicated by reference numeral 10. The device 10 is particularly suited for use with a work vehicle, for example a skid steer loader, having a tool supporting arm assembly, for example a pair of lift arms 12, which is typically used for supporting a tool thereon, for example a loader bucket. The work vehicle includes a hydraulic supply system including one or more controllable output circuits which may be connected to the device 10 for driving various movements of the device 10. A tool mounting bracket 14 is mounted on lift arms 12 to enable quick attachment of the pile cutting device 10 onto the lift arms 12 of the work vehicle.

The pile cutting device 10 generally includes a main frame 20 having two upright members 22 extending generally a full height of the main frame at the rear side thereof between opposing top and bottom ends of the main frame. A set of quick-connect mounting elements 24 are mounted on the upright members 22 to protrude from the rear side of the main frame which serve to selectively couple the device to the tool mounting bracket 14 of the work vehicle. The main frame 20 further includes a top crossbar 26 connected horizontally between the top ends of the upright members 22 and a bottom crossbar 28 connected between the bottom ends of the upright members 22.

A lower frame portion is provided in the form of two lower frame members 30 which protrude forwardly from the bottom ends of the two upright members 22 respectively, A bottom support plate 32 which is generally rectangular in shape spans laterally between the two lower frame members 30 and protrudes forwardly from the bottom crossbar 28 at the rear edge to an opposing front edge in alignment with the front ends of the lower frame members 30. A recessed opening 34 is provided at a laterally central location along the front edge of the bottom plate 32 in which the recessed opening is generally semicircular in shape about a central pile axis of the main frame which is aligned generally in a common vertical plane with the front edge of the bottom plate 32 and the front ends of the two lower frame members 30. The recessed opening 34 allows a pile to-be-cut to be at least partially received therein in a working position of the device 10 in which the pile to-be-cut is aligned along the pile axis of the device, as described in further detail below.

A lower clamp 36 is supported on the main frame 20 so as to be generally fixed in position relative to the main frame. The lower clamp 36 generally includes a rear clamping member 38 for engaging a rear side of the pile to-be-cut, and two clamping arms 40 for engaging an opposing front side of the pile to-be-cut such that the pile to-be-cut is effectively clamped between the rear clamping member 38 and the two clamping arms 40.

The rear clamping member 38 includes a stem 42 in the form of an elongate tube of square cross-section which is slidably mounted within a corresponding mounting sleeve 44 of mating internal profile. The mounting sleeve 44 is joined to the top side of the bottom plate 32 of the lower frame portion to protrude forwardly from a laterally central location on the bottom crossbar 28 such that a forward end of the mounting sleeve is in proximity to a peripheral edge of the recessed opening 34. The stem 42 is mounted within the sleeve so as to be slidable forward and back relative to the sleeve in a radial direction relative to the pile axis of the centre of the recessed opening 34. A channel member 46 is mounted at the forward end of the stem 42 which has a generally V-shaped cross-section. The channel member is oriented such that the two edges of the channel member comprise leading edges which are vertically oriented, laterally spaced apart at the forward end of the rear clamping member to form the point of contact with a pile to be cut. The central portion of the cross-section of the channel member is thus recessed rearwardly between the two leading edges. Cooperating apertures are provided in the stem 42 and the sleeve 44 to receive a suitable pin therein to selectively fix the radial position of the channel member relative to the main frame at a selected radial distance from the pile axis. The two leading edges of the channel member 46 are thus well suited for engaging piles of various diameters and cross-sections.

The two clamping arms 40 each comprise an arm portion 48 pivotally mounted at a rear end to the front end of a corresponding one of the lower frame members 30. Each arm portion is pivotal about a vertical pivot axis lying parallel to the pile axis such that the clamping arm portion 48 extends generally forwardly to a respective gripping portion 50 at the forward end of the arm portion. The gripping portion is a hollow tube member oriented vertically in perpendicular relationship to the arm portion.

The two clamping arms 40 are pivotal between a released position and a clamped position. In the released position, the clamping arms extend generally forwardly such that the gripping portions are spaced apart laterally by a distance which is approximately equal to the diameter of the opening 34 or greater, to allow insertion of the pile to-be-cut into the recessed opening 34 between the clamping arms. In the clamped position, the clamping arms extend forwardly and laterally inwardly towards one another such that the gripping portions 50 are closer together in the clamped position than in the released position. The gripping portions 50 are also closer to the rear clamping member 38 in the clamped position than in the released position for clamping the pile to-be-cut between the gripping portions 50 of the clamping arms and the rear clamping member 38.

Clamping motion of the clamping arms 40 is actuated by a pair of clamping actuators 52 in the form of a hydraulic linear actuators mounted between the main frame 20 and the two clamping arms 40 respectively. Each clamping actuator 52 is pivotally mounted at a rear end to the bottom crossbar 28 near the rear end of a respective one of the lower frame members 30, and is pivotally mounted at a front end to the arm portion 48 of a respective clamping arm 40 at a location spaced forwardly along the arm portion from the corresponding pivot axis at the rear end of the clamping arm. Extension and retraction of the clamping actuators effectively pivots the clamping arms between the released position and the clamped position thereof. The hydraulic actuators are coupled to a hydraulic output of the work vehicle so as to be controlled in unison from the controls of the work vehicle between the clamped and released positions thereof.

The main frame 20 also includes two support rails 54 extending vertically between the top crossbar 26 and the bottom crossbar 28 in proximity to the front sides of the two upright members 22. The support rails 54 are thus oriented parallel to the pile axis at laterally spaced apart positions on the main frame. Each support rail 54 has a dovetail shape in cross section which increases in the lateral dimension from a rear mounting portion mounted on the frame to a flat front edge of the rail.

The device 10 further includes a cutting assembly 56 above the lower clamp 36 for cutting a pile received along the pile axis of the device within the lower clamp, and an upper clamp 58 above the cutting assembly for clamping a section of the pile to-be-cut from the remainder of the pile to assist in lifting off and removing the cut pile section. Each of the cutting assembly 56 and the upper clamp 58 are independently supported on the two support rails 54 for vertical sliding adjustment of height relative to the main frame and the lower clamp independently of one another as described in further detail below.

The upper clamp 58 is supported on a carriage frame which is slidably supported on the support rails 54 of the main frame. The carriage frame includes two uprights 60 which are laterally spaced apart at the rear side of the carriage frame to extend parallel to and alongside respective ones of the two support rails 54. Two followers 62 are mounted along the rear side of each upright 60 which mate for relative sliding along the respective support rail 54. Each follower comprises a block having a dovetail shaped slot extending vertically therethrough which matches the profile of the corresponding portion of the support rail. The surfaces of the slot within each follower comprise a plastic material having a low coefficient of friction for smooth sliding along the rails.

The carriage frame further includes a top crossbar 64 extending horizontally between top ends of the two uprights 60 and a bottom crossbar 66 extending horizontally between the bottom ends of the two uprights 60 at the rear side of the carriage frame. Two lower frame members 68 protrude horizontally forward from the bottom crossbar 66 at laterally spaced positions thereon to respective forward ends situated at diametrically opposing sides of the pile axis. Similarly, two upper frame members 70 protrude horizontally forward from the top crossbar 64 at laterally spaced positions thereon to respective forward ends situated at diametrically opposing sides of the pile axis, spaced above the forward ends of the lower frame members 68. Two front posts 72 are each connected vertically between the forward end of a respective lower frame member 68 and the forward end of a respective upper frame member 70.

For added structural integrity, a lower plate 74 spans horizontally across the bottom side of the two lower frame members 68 and an upper plate 76 spans horizontally across the top side of the two upper frame members 70, Each of the upper and lower plates has a rear edge joined to a respective one of the crossbars 64 and 66 at the rear side of the carriage frame, and protrudes forwardly to a front edge lying substantially in a common vertical plane with the front edge of the bottom plate 32 of the lower frame portion of the device 10. The front edge of each plate 74 and 76 also includes a recessed opening 78 formed therein at a laterally central location which is generally semicircular in shape about the pile axis similarly to the opening 34 in the bottom plate 32.

The upper clamp 58 supported on the carriage frame generally includes a rear clamping member 80 at a laterally central location at the rear of the recesses 78 which is adjustable in a radial direction relative to the pile axis for engaging the rear side of the pile to-be-cut, and two clamping arms 82 which are pivotal between clamped and released positions relative to the rear clamping member similarly to the configuration of the two clamping arms 40 movable relative to the rear clamping member 38 of the lower clamp 36.

The rear clamping member 80 includes an upright channel member 84 which is generally V-shaped in cross-section such that a trough portion of the channel is recessed rearwardly relative to the two leading edges of the channel member at the forward end of the channel member for engaging the pile to-be-cut. The two leading edges are laterally spaced apart and parallel to the pile axis of the device. The channel member is supported for radial adjustment relative to the pile axis by two stems 86 protruding rearward from vertically spaced positions on the channel member 84 in proximity to the upper plate 76 and lower plate 74 respectively. A pair of mounting sleeves 88 are mounted on the upper plate 76 and the lower plate 74 respectively such that each mounting sleeve lies in a common plane with a pair of the upper frame members or a pair of the lower frame members respectively. Each sleeve is fixed at a rear end on the respective one of the crossbars 64 or 66 of the carriage frame to extend forwardly therefrom to respective forward ends located in proximity to the peripheral edge of the recessed opening 78. The stems 86 are square in cross-section for mating with the square internal cross-section of the sleeves 88 respectively such that the channel member 84 is adjusted in a radial distance relative to the pile axis as the stems slide in and out of the respective sleeves. Cooperating apertures are provided in each of the stems 86 and the mounting sleeves 88 to receive a pair of locking pins therein which selectively fixes the rear clamping member at a selected radial distance from the pile axis. In this manner, the leading edges of the rear clamping member are suited for accommodating different diameters and cross-sectional shapes of piles to-be-cut similarly to the lower clamp.

Each of the clamping arms 82 of the upper clamp 58 includes an upper arm portion 90 and a lower arm portion 92 pivotally mounted at the rear ends thereof onto the forward ends of a respective upper frame member 70 and a respective lower frame member 68. The upper arm portion 90 and the lower arm portion 92 of each clamping arm 82 are connected to one another by a gripping portion 94 extending vertically therebetween, parallel to the pile axis, at the forward free end of the respective clamping arm. The gripping portion is a hollow tube of rectangular cross-section suited for directly engaging the pile to-be-cut in the clamped position.

The two clamping arms 82 are pivotal between a released position and a clamped position. In the released position, the clamping arms 82 extend generally forwardly such that the gripping portions 94 are spaced apart at laterally by a distance which is approximately equal to the diameter of the openings 78 or greater, to allow insertion of the pile to-be-cut into the recessed opening 78 between the clamping arms 82. In the clamped position, the clamping arms extend forwardly and laterally inwardly towards one another such that the gripping portions 94 are closer together in the clamped position than in the released position. The gripping portions 94 are also closer to the rear clamping member 80 in the clamped position than in the released position for clamping the pile to be cut between the gripping portions 94 of the clamping arms and the rear clamping member 80.

Clamping motion of the clamping arms 82 is actuated by a pair of clamping actuators 96 in the form of hydraulic linear actuators mounted between the carriage frame of the upper clamp and the two clamping arms 82 respectively. Each clamping actuator 96 is pivotally mounted at a rear end to the bottom crossbar 66 near the rear end of a respective one of the lower frame members 68, and is pivotally mounted at a front end to the lower arm portion 92 of a respective clamping arm 82 at a location spaced forwardly along the arm portion from the corresponding pivot axis at the rear end of the clamping arm. Extension and retraction of the clamping actuators 96 effectively pivots the clamping arms between the released position and the clamped position thereof. The hydraulic actuators are coupled to a hydraulic output of the work vehicle so as to be controlled in unison from the controls of the work vehicle between the clamped and released positions thereof.

The position of the carriage frame of the upper clamp 58 relative to the main frame is controlled by two position actuators 98. Each actuator 98 is a hydraulic linear actuator mounted approximately in a common plane with the two upright members 22 of the main frame. More particularly the two actuators 98 are mounted generally parallel to the pile axis at laterally spaced positions relative to one another such that each actuator extends between a top end coupled to the top crossbar 64 of the carriage frame and a bottom end coupled to the bottom crossbar 28 of the main frame. The hydraulic actuators are coupled to a hydraulic output of the work vehicle so as to be controlled in unison from the controls of the work vehicle. The actuators allow displacement of the carriage frame of the upper clamp between a raised position closer to the top end than the bottom end of the main frame 20 when the actuators are fully extended, and a lowered position, in which the carriage frame is closer to the bottom end of the main frame than in the raised position when the actuators are retracted.

The cutter assembly 56 for cutting the pile is similarly supported on a respective carriage frame for vertical adjustment along the support rails of the main frame of the device 10. The carriage frame of the cutting assembly includes two rear uprights 100 which are laterally spaced apart at the rear side of the carriage frame to extend parallel to and alongside respective ones of the two support rails 54. Two followers 102 are mounted along the rear side of each upright at vertically spaced positions which mate for relative sliding along the respective support rail 54. Each follower comprises a block having a dovetail shaped slot extending vertically therethrough which matches the profile of a corresponding portion of the support rail received therein. The surfaces of the slot within each follower comprising a plastic material having a low coefficient of friction force to sliding along the rails.

The carriage frame of the cutter assembly 56 further includes a top crossbar 100 for extending horizontally between the top ends of the two uprights 100 and a bottom crossbar 106 extending horizontally between the bottom ends of the two uprights 100 at the rear side of the carriage frame. Two lower frame members 108 protrude horizontally forward from the bottom crossbar 106 at laterally spaced positions thereon to respective forward ends situated at diametrically opposing sides of the pile axis. Similarly, two upper frame members 110 protrude horizontally forward from the top crossbar 104 at laterally spaced positions thereon to respective forward ends situated at diametrically opposing sides of the pile axis, spaced above the forward ends of the lower frame members 108. Two front post 112 are each connected vertically between the forward end of a respective lower frame member 108 and the forward end of a respective upper frame member 110.

Position of the carriage frame of the cutting assembly 56 relative to the main frame is controlled by two position actuators 114. Each actuator 114 is a hydraulic linear actuator mounted approximately in a common plane with the two frame members 22 of the main frame. More particularly the two actuators 114 are mounted generally parallel to the pile axis at laterally spaced positions relative to one another at laterally opposing sides of the two position actuators 98 which control position of the upper clamp member 58 relative to the main frame. Each actuator 114 extends between a top end coupled to the top crossbar 26 of the main frame and a bottom end coupled to the top crossbar 104 of the carriage frame of the cutting assembly. The hydraulic actuators 114 are coupled to a hydraulic output of the work vehicle so as to be controlled in unison from the controls of the work vehicle. The actuators allow displacement of the carriage frame of the cutting assembly between a lowered position adjacent to the lower clamp at the bottom end of the main frame when the actuators are fully extended, and a raised position in which the carriage frame is spaced above the lowered position when the actuators are retracted.

The cutting assembly 56 generally includes (i) a support member 116 comprising a horizontal plate member mounted generally perpendicularly to the pile axis, (ii) a linkage member 118 supported on the support member 116 for sliding on the support member in a generally circumferential direction, and (iii) a rotary saw blade 120 rotatably supported on the linkage member for adjustment in a generally radial direction of the pile axis relative to the linkage member. In this manner, the rotary saw blade is supported for adjustment through a range of at least 360° in a circumferential direction about a pile received at the pile axis within the pile cutting device 10, while also being able to accommodate different pile diameters.

The support member 116 is mounted at a rear edge by a spherical bushing 122 coupled between the support member and a laterally central location on the lower crossbar 106 of the carriage frame of the carriage assembly. Two suspension members 124 are each connected in a vertical orientation, parallel to the pile axis between respective bottom ends at laterally opposing side edges of the support member 116 and respective top ends supported on the two front posts 112 respectively in proximity to the upper frame members 110. The two suspension members 124 are thus situated at diametrically opposing sides of the pile axis. Adjustment of the length of the two suspension members together with the free pivotal connection of the spherical bushing 122 at the rear side of the support member enables the support member to be adjusted in angular orientation away from a neutral orientation normal to the pile axis in any direction from the pile axis to accommodate for minor misalignments between the pile to-be-cut and the longitudinal direction of the main frame.

A front edge of the support member 116 is situated to lie generally in a common vertical plane with the front edges of the upper and lower plates of the carriage frame of the upper clamp 58 as well as the front edge of the bottom plate 32 of the lower frame portion. A recess opening 126 is similarly provided in the front edge of the plate forming the support member 116 which is semicircular in shape having an edge which is circumferentially oriented about the pile axis in alignment with the corresponding semicircular edges of the recesses 78 and 34. The support member 116 is thus generally C-shaped so as to extend in a circumferential direction about the pile axis between two opposing ends 126 defining a circumferential gap therebetween enabling a pile to-be-cut to be inserted therein in operation.

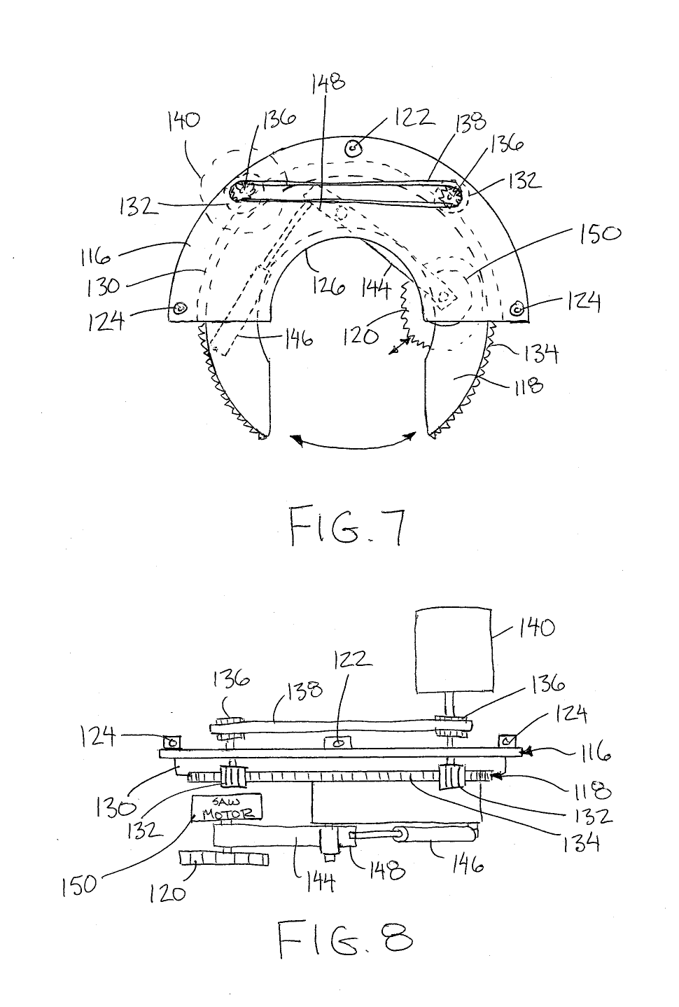

The linkage member 118 is an arcuate member which is also generally C-shaped in a circumferential direction about the pile axis between two opposing ends 128 of the linkage member for defining a circumferential gap therebetween. A slider channel 130 is mounted on the bottom side of the support member 116 which mates with a corresponding portion of the linkage member 118 received therein to support the linkage member for sliding movement relative to the support member in the circumferential direction about the pile axis. The linkage member can be initially positioned in a neutral position as shown in FIG. 7 in which the circumferential gap of the linkage member is aligned and centred in the circumferential direction with the corresponding circumferential gap in the support member 116. In the neutral position, the dimension of the circumferential gap in the linkage member is approximately equal to the diameter of the recess opening 126 to readily allow insertion of a pile to-be-cut therethrough. The linkage member 118 is supported to be movable through a range of at least 180° in either direction from the neutral position towards two circumferentially opposed deflected positions. The two deflected positions are thus 360 apart from one another to enable the rotary saw 120 supported on the linkage member to be supported for a complete revolution about the pile axis in the circumferential direction.

Displacement of the linkage member relative to the support member 116 is controlled by a drive system including to drive gears 132 rotatably supported below the support member 116 in proximity to the outer peripheral edge of the linkage member for rotation about respective drive axes oriented parallel to the pile axis. A rack of gear teeth 34 extends circumferentially about the outer peripheral edge of the linkage member 118 through a range of approximately 270° so as to be interrupted only by the circumferential gap between the opposed ends 128 of the linkage member. The drive gears 32 have gear teeth thereon which are suitably arranged for meshing engagement with the rack of gear teeth 134. The two drive gears 132 are spaced apart from one another in a circumferential direction about the pile axis by a distance which is greater than the circumferential gap in the rack of gear teeth 134, for example circumferential distance of at least 90 degrees when the rack of gear teeth extends through 270 degrees, such that at least one of the two drive gears 32 is in meshing engagement with the rack of gear teeth at all times throughout the complete rotation of the linkage member 118 relative to the support member 116.

Each drive gear 132 is fixed for rotation together along a common axle with a respective input gear 136 above the support member 116. A drive chain 138 is coupled between the two input gears 136 with suitable gearing to ensure that the two drive gears are rotated together to enable both gears to rotate simultaneously in meshing engagement with the common rack of gear teeth 134 of the linkage member 118. A hydraulic motor 140 is mounted on the support member 116 and has a rotary output coupled to one of the input gears 136. The hydraulic motor is connected to a hydraulic output of the work vehicle so as to enable position of the linkage member relative to the support member to be controlled using controls of the work vehicle.

The rotary saw blade 120 is rotatably supported relative to the linkage member by a support arm 144 below the linkage member. The support arm 144 is pivotally supported at an inner end to the bottom of the linkage member 118 at a laterally central location at the rear side thereof in the neutral position for pivotal movement about a pivot axis oriented parallel to the pile axis. The support arm 144 extends generally tangentially relative to the pile axis from the inner end to an opposing outer end of the support arm which rotatably supports the saw blade 120 thereon about a saw axis which is also parallel to the pile axis. In this manner, pivoting the support arm relative to the linkage member effectively controls the radial positioning of the saw blade relative to the pile axis.

Positioning of the support arm relative to the linkage member is controlled by a saw actuator 146 in the form of a hydraulic linear actuator which is coupled at one end to the linkage member and coupled at an opposing end to an input crank 148. The input crank 148 protrudes from the pivot axis of the support arm diametrically opposite from the support arm 144 so as to be rotatable about the pivot axis together with the support arm. The saw actuator 146 can be extended and retracted in such a manner to drive pivoting of the input crank and the corresponding support arm about the pivot axis, which in turn displaces the rotary saw blade at the outer end of the support arm 144 in a radial direction relative to the pile axis. The saw actuator 146 is connected to a hydraulic output of the work vehicle so as to enable positioning of the saw blade in a radial direction using controls of the work vehicle.

A saw motor 150 is also mounted on the outer end of the support arm at the axis of the saw blade 120 in the form of a hydraulic motor having a rotary output which drives rotation of the saw blade. The hydraulic motor is connected to a hydraulic output of the work vehicle so as to enable rotation of the saw blade to be actuated and controlled using controls of the work vehicle.

In operation, the pile cutting device 10 is supported on a work vehicle using the quick connecting elements 24 for attachment to a suitable tool mounting bracket of the work vehicle. Initially the rear clamping members of the upper and lower clamps are fixed at a selective radial distance from the pile axis corresponding to the diameter of the pile to be cut. With the cutting assembly initially in the neutral position, and both upper and lower clamps released, the work vehicle can be advanced towards the pile to insert the pile to-be-cut into the respective recessed openings of the upper and lower clamps and the cutting assembly to align the pile substantially with the pile axis of the device 10. The lower clamp can then be displaced to a clamped position to substantially fix the main frame of the device 10 relative to the pile to-be-cut. The height of the culling assembly can then be adjusted relative to the lower clamp to ensure that the rotary saw 120 is precisely aligned at the prescribed height along the pile where the pile is to be cut. Similarly, the height of the upper clamp can then be adjusted along the section of pile to-be-cut from the remainder of the pile penetrated in the ground. Clamping the upper clamp about the pile section to be cut thus ensures that the cut pile section is safely contained and prevented from falling subsequent to cutting.

The cutting operation may begin by initially rotating the linkage member in one direction from the neutral position to one of the deflected positions. The saw motor can then be actuated to drive rotation of the saw blade and the saw actuator 146 can also be controlled to advanced the saw blade radially inwardly towards the pile to be cut. Once the saw blade has been advanced into the pile to initiate the cut, the corresponding motor 140 which controls circumferential position of the linkage member relative to the support member can be actuated to displace the saw about the full circumference of the pile by displacing the linkage member from one deflected position to the opposing deflected position through the neutral position therebetween. Once the pile has been cut about the full circumference thereof, the saw blade can be radially withdrawn from the pile using the saw actuator 146 and the linkage member can be returned to the neutral position of FIG. 7. The position actuators of the upper clamp can also be actuated to lift off the cut pile section from the remainder of the pile penetrated into the ground. Releasing the lower clamp then enables the work vehicle to be withdrawn away from the remainder of the pile penetrated in the ground while the cut pile section remains clamped within the upper clamp for subsequent disposal at a suitable location.

In further embodiments, all of the hydraulic actuators and motors of the pile cutting device 10 may be coupled to a single hydraulic output of the work vehicle through a suitable control assembly of valves which provide independent control to a plurality of intermediate outputs of the control assembly connected to respective ones of the actuators and motors of the pile cutting device 10. The control assembly in this instance may be incorporated into the pile cutting device 10, incorporated into the work vehicle, or may be provided as a separate intermediate component between the work vehicle and the pile cutting device 10.

Since various modifications can be made in my invention as herein above described, and many apparently widely different embodiments of same made, it is intended that all matter contained in the accompanying specification shall be interpreted as illustrative only and not in a limiting sense.

1. A pile cutting device for use with a work vehicle including a tool supporting arm assembly for cutting a pile, the device comprising:
a main frame arranged to be supported on the arm assembly of the work vehicle;
a first clamp supported on the main frame and arranged to be clamped about the pile when the pile is received along a pile axis of the pile cutting device for fixing the main frame relative to the pile;
a cutting assembly including (i) a cutter linkage which is supported on the main frame above the first clamp, and (ii) a saw blade rotatably supported on the cutter linkage so as to be movable with the cutter linkage relative to the main frame so as to be arranged to cut a cut pile section from the pile when the pile remains secured within the lower clamp along the pile axis of the pile cutting device; and
a second clamp supported on the main frame in alignment with the first clamp along the pile axis of the pile cutting device so as to be arranged to be clamped about the cut pile section of the pile.

2. The device according to claim 1 wherein the cutting assembly is supported on the main frame so as to be adjustable in height relative to the first clamp and the second clamp in a direction of the pile axis.

3. The device according to claim 2 wherein the cutter linkage is arranged to support the saw blade for movement in a circumferential direction relative to the pile axis about a full circumference of the pile received in the first and second clamps.

4. The device according to claim 3 wherein the cutter linkage comprises a support member mounted on the main frame which is arranged to extend circumferentially partway about the pile axis, and a linkage member supported on the support member to extend circumferentially partway about the pile axis, the linkage member supporting the saw blade rotatably thereon and being movement in the circumferential direction relative to the support member.

5. The device according to claim 4 wherein each of the support member and the linkage member is generally C-shaped so as to define a circumferential gap between opposing ends of the respective member, and wherein the linkage member is movable in two opposing directions from a neutral position in which the circumferential gaps are aligned with one another for receiving the pile therethrough towards two deflected positions respectively in which the deflected positions are 360 degrees apart from one another in the circumferential direction.

6. The device according to claim 5 wherein the cutter linkage includes a pair of driving gears rotatably supported on the support member for rotation about respective gear axes oriented parallel to the pile axis and a rack of gear teeth on the linkage member along an circumferential path about the pile axis, the driving gears being spaced apart in the circumferential direction by a distance which is greater than the circumferential gap on the linkage member such that at least one driving gear is arranged for meshing engaging with the rack of gear teeth throughout displacement of the linkage member relative to the support member.

7. The device according to claim 4 wherein the support member is supported on the main frame so as to be adjustable in orientation relative to the pile axis of the main frame.

8. The device according to claim 3 wherein the saw blade is supported on the cutter linkage so as to be adjustable in a radial direction relative to the pile axis of the main frame.

9. The device according to claim 1 in combination with the pile wherein the saw blade has a radius which is less than a diameter of the pile.

10. The device according to claim 1 wherein the second clamp is supported on the main frame so as to be adjustable in height relative to the main frame, the first clamp, and the cutting assembly in a direction of the pile axis.

11. The device according to claim 10 wherein the main frame includes at least one support rail extending in a direction of the pile axis, and wherein the second clamp and the cutting assembly are independently supported on said at least one support rail of the main frame so as to be independently adjustable in height relative to the main frame in the direction of the pile axis.

12. The device according to claim 1 wherein the second clamp comprises a rear clamping member arranged to be supported in fixed relation to the main frame rearwardly of the pile axis and a pair of clamping arms pivotally supported at laterally opposing sides of the rear clamping member to protrude from the main frame forwardly of the pile axis, the clamping arms being pivotal about a pivot axis oriented in the direction of the pile axis between a released position arranged to receive the pile inserted therebetween into the second clamp and a clamped position arranged to clamp the pile between the rear clamping member and the pair of clamping arms.

13. The device according to claim 12 wherein the rear clamping member of the second clamp is adjustable relative to the main frame in a radial between a plurality of different mounted positions.

14. The device according to claim 12 wherein the rear clamping member of the second clamp comprises a channel member comprising two leading edges extending in a direction of the pile axis which are arranged to engage the pile and a connection portion joined between the two leading edges.

15. The device according to claim 1 wherein the first clamp comprises a rear clamping member arranged to be supported in fixed relation to the main frame rearwardly of the pile axis and a pair of clamping arms pivotally supported at laterally opposing sides of the rear clamping member to protrude from the main frame forwardly of the pile axis, the clamping arms being pivotal about a pivot axis oriented in the direction of the pile axis between a released position arranged to receive the pile inserted therebetween into the second clamp and a clamped position arranged to clamp the pile between the rear clamping member and the pair of clamping arms.

16. The device according to claim 15 wherein the rear clamping member of the first clamp is adjustable relative to the main frame in a radial between a plurality of different mounted positions.

17. The device according to claim 12 wherein the rear clamping member of the first clamp comprises a channel member comprising two leading edges extending in a direction of the pile axis which are arranged to engage the pile and a connection portion joined between the two leading edges.

18. The device according to claim 1 in combination with the work vehicle, wherein the work vehicle comprises a skid steer loader and the tool supporting arm assembly comprises lift arms of the skid steer loader.

19. A pile cutting device for use with a work vehicle including a tool supporting arm assembly for cutting a pile, the device comprising:
a main frame arranged to be supported on the arm assembly of the work vehicle for receiving the pile therein along a pile axis of the pile cutting device;
an upper clamp supported on the main frame so as to be arranged to be clamped about a pile section to be cut from the pile.
a cutting assembly including (i) a cutter linkage which is supported on the main frame below the upper clamp, and (ii) a saw blade rotatably supported on the cutter linkage so as to be movable with the cutter linkage relative to the main frame so as to be arranged to cut said pile section from the pile;
the upper clamp being supported on the main frame so as to be adjustable in height relative to the main frame, and the cutting assembly in a direction of the pile axis.

20. A pile cutting device for use with a work vehicle including a tool supporting arm assembly for cutting a pile, the device comprising:
a main frame arranged to be supported on the arm assembly of the work vehicle for receiving the pile therein along a pile axis of the pile cutting device; and
a cutting assembly including (I) a cutter linkage which is supported on the main frame, and (ii) a saw blade rotatably supported on the cutter linkage so as to be movable with the cutter linkage relative to the main frame so as to be arranged to cut a cut pile section from the pile when the pile is received along the pile axis of the pile cutting device;
the cutter linkage being arranged to support the saw blade for movement in a circumferential direction relative to the pile axis about a full circumference of the pile received within the pile cutting device.
